(19) United States
(12) Patent Application Publication
(10) Pub. No.: US 2021/0243997 A1
(43) Pub. Date: Aug. 12, 2021

(54) CONNECTED PET TREATS AND APPARATUS FOR DISPENSING THE TREATS

(71) Applicant: PAWZ DOG BOOTS LLC, Brooklyn, NY (US)

(72) Inventors: Michael FRIEDLAND, Brooklyn, NY (US); Chris MELLEN, Yonkers, NY (US); Louis F. HENRY, Scarsdale, NY (US)

(73) Assignee: PAWZ DOG BOOTS LLC, Brooklyn, NY (US)

(21) Appl. No.: 17/078,347

(22) Filed: Oct. 23, 2020

Related U.S. Application Data
(63) Continuation of application No. PCT/US2019/028815, filed on Apr. 23, 2019.
(60) Provisional application No. 62/661,578, filed on Apr. 23, 2018.
(60) Provisional application No. 62/702,149, filed on Jul. 23, 2018.

(51) Int. Cl. A01K 5/02

(52) U.S. Cl. CPC A01K 5/02

(57) ABSTRACT

The present disclosure provides a body of a plurality of interconnected pet treats, and a dispenser for dispensing the treats to a pet. The body can comprise a mass of edible extruded, poured, or molded material, that is shaped so that individual treats can be broken or cut off. The treats can be interconnected by a portion of the edible extruded, poured, or molded material that is thinner in a certain area to facilitate the separation of the treats. The dispenser uses a housing, treat sleeve, and trigger sleeve so that a user can load the treats into the treat sleeve, and selectively eject individual treats semi-automatically.

### CROSS REFERENCE TO RELATED APPLICATION

The present application is a continuation of International Patent Application No. PCT/US2019/028815, filed on Apr. 23, 2019, which designates the U.S., is published in English, and claims the benefit of U.S. Provisional Application No. 62/661,578, filed on Apr. 23, 2018 and U.S. Provisional Application No. 62/702,149 filed on Jul. 23, 2018. The disclosures of each of the above-referenced applications are incorporated herein by reference.

### BACKGROUND OF THE DISCLOSURE

### 1. Field of the Disclosure

The present disclosure relates to the field of treats that can be given to pets. More particularly, the present disclosure relates to treats that are connected to one another, so that they can be easily broken off or separated. The treats may be administered with a dispensing device.

### 2. Discussion of the Related Art

Edible treats can be used to train animals, to reward or encourage good behavior. Currently, people typically carry a baggy of treats, or (perhaps with a professional trainer) a treat pouch on a belt. Treats are dirty and stinky, and thus undesirable to handle. Further, after fumbling around to grab a treat the animal (e.g., a dog) may become excited and may not take the treat gently, and instead bite the finger of the person administering the treat.

There is a need to alleviate these problems with the current state of the art. The dispenser and connected treats of the present disclosure will allow people to easily and conveniently, cleanly and safely reward the dog with a treat.

### SUMMARY OF THE DISCLOSURE

The present disclosure provides a body comprising a plurality of joined treats. The treats are connected to one another such that they can be easily broken off and given or dispensed to a pet. This alleviates the concern of having to store loose treats in a messy or inconvenient fashion.

The present disclosure also provides a device for dispensing the joined treats. As discussed in further detail below, the device is handheld and portable, and the body of joined treats can be loaded into the device. With a trigger mechanism, a user can separate a single treat from the body and dispense it to the animal. The device is such that the user's hands do not need to be dangerously close to the mouth of the animal. The dispensers of the present disclosure can be used to dispense the treat bodies discussed herein, or can also be used to dispense one or more treats that are loose or unconnected to one another.

As used in the present disclosure, the term “treat” refers to an edible food product that is typically made of compressed, dried, or baked materials such as proteins, flour or other fillers, binders, sweeteners and other suitable materials. As discussed below, the treats of the present disclosure can be prepared by extruding, pouring, or otherwise placing the desired materials into a mold. The treats of the present disclosure can be prepared with heat or energy, e.g., baked, or dried or formed in the mold without applied heat energy. The treats of the present disclosure are formed, baked, or extruded so that the treats are interconnected to one another in one or more of several ways.

As used in the present disclosure, the term “substantially” means a majority, i.e. greater than 50%. It may also mean 60% or greater, 70% or greater, 80% or greater, or 90% or greater. Thus, as one example, when an item is “substantially” within an enclosure, greater than 50% of the item is within the enclosure, 60% or greater is, 70% or greater is, 80% or greater is, or 90% or greater is.

Thus, in one embodiment, the present disclosure provides a dispenser for dispensing a plurality of pet treats. The dispenser comprises a housing comprising a hollow interior, and a treat sleeve comprising a hollow interior for storing the pet treats. The treat sleeve selectively moves from an extended position substantially protruding from the housing, and a retracted position substantially within the hollow interior of the housing. The dispenser also comprises a trigger sleeve having a hollow interior, wherein the trigger sleeve is pivotably connected to the housing at a first end of the trigger sleeve, and comprises a pusher at a second end of the trigger sleeve. When the trigger sleeve is in a first position, the trigger sleeve is substantially outside the housing, and when the trigger sleeve is in a second position, the trigger sleeve is substantially within the hollow interior of the housing.

In another embodiment, the present disclosure provides a treat body comprising a plurality of interconnected treats, wherein the treat body comprises a mass of edible material. The mass comprises cutaway positions, so that the plurality of treats are interconnected to one another by narrow connection points made of the material, so that the treats can be separated individually.

In another embodiment, the present disclosure provides a dispenser comprising a housing and a trigger sleeve, wherein the trigger sleeve is pivotably connected to the housing, and an interior space is defined by the housing and the trigger sleeve. The dispenser further comprises a treat body in the interior space, wherein the treat body comprises a plurality of treats made of a mass of edible material,. The mass comprises cutaway positions, so that the plurality of treats are interconnected to one another by narrow connection points made of the material, so that the treats can be separated individually. The dispenser also comprises an opening in the housing, so that when the trigger sleeve moves from a first position to a second position, one of the plurality of treats is detached from the treat body and passed through the opening.

### BRIEF DESCRIPTION OF THE FIGURES

FIGS. 1a and 1b show an embodiment of the body of the present disclosure, with a plurality of joined treats.

FIGS. 2a, 2b, and 2c show a first side, second side, and perspective view of a first treat of the present disclosure.

FIGS. 3a, 3b, and 3c show a first side, second side, and perspective view of a second treat of the present disclosure.

FIG. 4 shows a second embodiment of the body of the present disclosure, with a plurality of joined treats.

FIG. 5a shows a third embodiment of the body of the present disclosure, with a plurality of joined treats.

FIG. 5b shows the embodiment of the body of FIG. 5a, with the plurality of joined treats bent and separated.

FIG. 6 shows a fourth embodiment of the body of the present disclosure, with a plurality of joined treats.

FIG. 7 shows a fifth embodiment of the body of the present disclosure, with a plurality of joined treats.

FIG. 8 shows a mold for manufacturing the treats of the present disclosure.

FIGS. 9a and 9b show perspective and side exploded views, respectively, of a first embodiment of a dispenser of the present disclosure.

FIGS. 10a, 10b, and 10c show first side, second side, and cross-sectional views, respectively, of the dispenser of FIGS. 9a and 9b with a treat sleeve in an extended position.

FIGS. 11a, 11b, and 11c show first side, second side, and cross-sectional views, respectively, of the dispenser of FIGS. 9a and 9b with the treat sleeve in loaded, retracted position.

FIGS. 12a, 12b, and 12c show first side, second side, and cross-sectional views, respectively, of the dispenser of FIGS. 9a and 9b with the treat sleeve in loaded, retracted position, and the trigger in a collapsed position.

FIG. 13 shows a close-up view of the bottom of the sleeve of the dispenser of FIGS. 9a and 9b.

FIGS. 14a and 14b show first and second side views, respectively, of the dispenser of FIGS. 9a and 9b with the treat sleeve in a partially extended position.

FIGS. 14c and 14d show a bottom perspective view of the dispenser of FIGS. 9a and 9b with the treat sleeve in a retracted and partially extended position, respectively.

FIG. 15a shows a top, perspective view of a dispenser according to the present disclosure.

FIG. 15b shows a top, perspective view of a treat body made with the mold of FIG. 8.

FIG. 15c shows a side, partially transparent view of the dispenser of FIG. 15a.

FIG. 15d shows a second side, partially transparent view of the dispenser of FIG. 15a, with a trigger in pressed position.

FIG. 15e shows a third side, partially transparent view of the dispenser of FIG. 15a.

FIG. 15f shows a fourth side, partially transparent view of the dispenser of FIG. 15a, in a pre-loaded state.

FIG. 15g shows the fourth side, partially transparent view of the dispenser of FIG. 15a, in a pre-loaded state, with a front loader opened.

FIG. 15h shows the fourth side, partially transparent view of the dispenser of FIG. 15a, with a treat body loaded therein.

FIG. 15i shows the fourth side, partially transparent view of the dispenser of FIG. 15a, with a treat body loaded therein, with a trigger pressed.

FIG. 15j shows the fourth side, partially transparent view of the dispenser of FIG. 15a, with a treat body loaded therein, with the trigger pressed, and the treat body pushed downward.

FIG. 15k shows a detail view of the fourth side, partially transparent view of the dispenser of FIG. 15a, showing a pusher in a first position.

FIG. 15l shows a second detail view of the fourth side, partially transparent view of the dispenser of FIG. 7f, showing the pusher in a second position.

FIG. 15m shows a third detail view of the fourth side, partially transparent view of the dispenser of FIG. 15a, showing a treat partially ejected.

FIG. 15n shows a detail view of the exterior of the dispenser of FIG. 7a, showing a treat partially ejected.

### DETAILED DESCRIPTION OF THE DISCLOSURE

The treats and dispenser of the present disclosure allow for the clean and convenient dispensing of treats to an animal. When using the dispenser of the present disclosure, a user does not have to handle the treat themselves. This enables the user to keep their hands clean, and also away from the mouths of the pet. Further, the treats are interconnected to one another in the manner described below, which eliminates the need to load treats one by one into a dispenser.

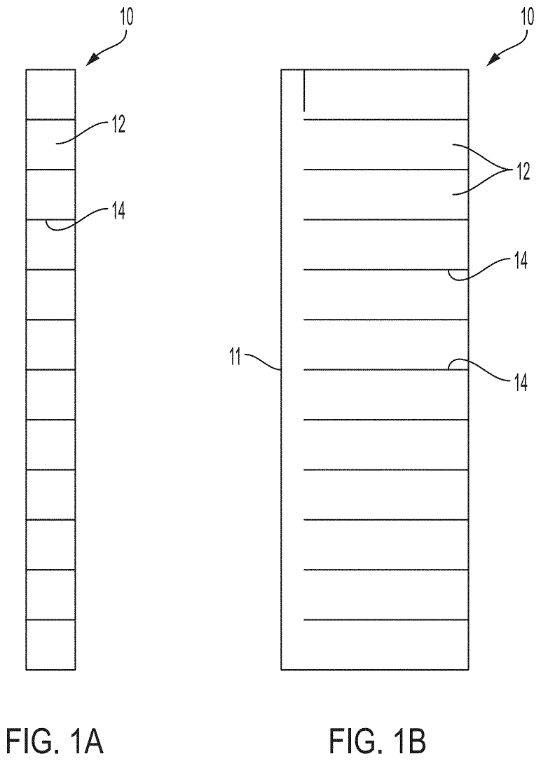

Referring to the drawings, and in particular FIGS. 1-8, a body 10 of the present disclosure is shown. Body 10 comprises a plurality of interconnected treats 12. In the embodiment of FIG. 1, the treats can have a shape that is substantially a rectangular solid and connected to one another along an outer edge 11. As shown in the other Figures, however, treats 12 can have other shapes, such as but not limited to circular, square, rectangular, diamond, or triangular three-dimensional solids. The connection edge 11, to one side of treats 12, can be made of the material used to form the treats. For body 10, the material of the treats 12 can be extruded, formed, or molded as a sheet or block, and dried if needed.

In the embodiment of FIG. 1, body 10 is made by taking the block or sheet described above, and cutting or slicing along partition lines 14. Treats 12 should be only partially cut away, so that they are connected to one another via connection edge 11. Thus, lines 14 do not extend the entire length or width of body 10. Edge 11 should only be strong enough so that treats 12 can be broken off or separated by hand or with the device discussed in greater detail below.

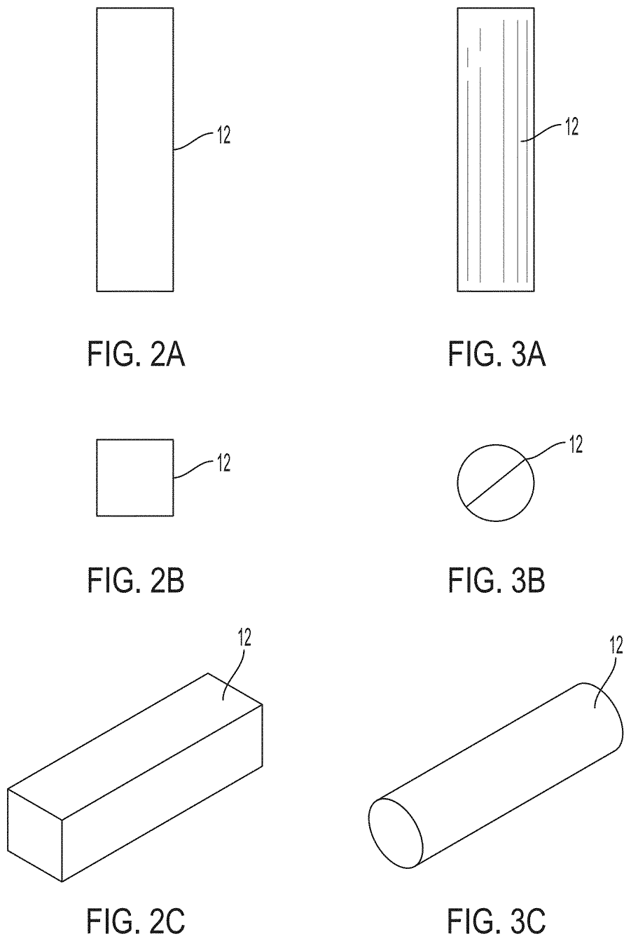

FIGS. 2a, 2b, and 2c show one type of treat 12, that is square or rectangular in cross-section. FIGS. 3a, 3b, and 3c show a second type of treat 12, that is circular in cross-section. The length and thickness of treat 12 should be such that it can be used in the dispensers of the present disclosure, so that the dispensers are still compact enough for portable use and convenient to store (for example in a pocket or pouch). In one embodiment, the length of treats 12 can be three inches or less, in another embodiment two inches or less, and in another embodiment one inch or less. The thickness or diameter can be one inch or less, one half inch or less, or one quarter inch or less.

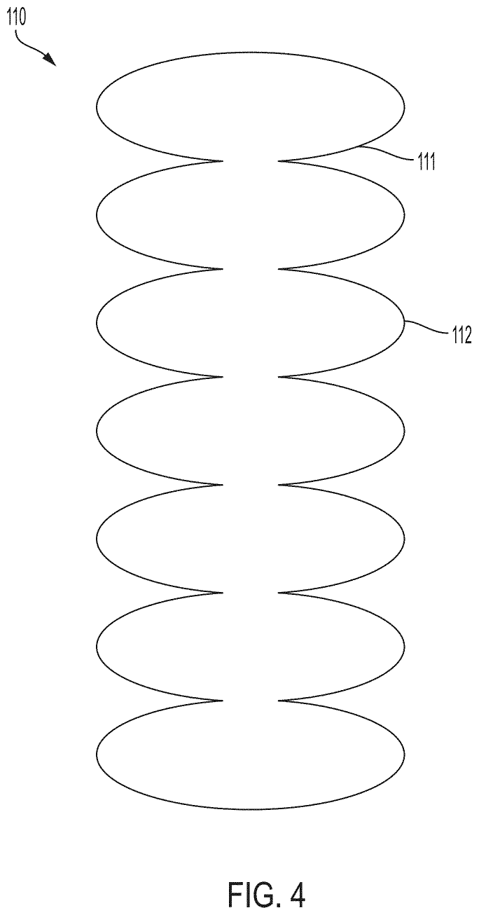

FIG. 4 shows a body 110 and treats 112. In this embodiment, treats 112 have an elliptical shape, and are connected to one another at connection point 111. Similarly to body 10, connection point 111 can be made of the same material that treats 112 are made of. In addition, like edge 11, connection point 111 should be strong enough to hold treats 112 together, but can break when a user applies hand pressure or uses a device to separate treats 112.

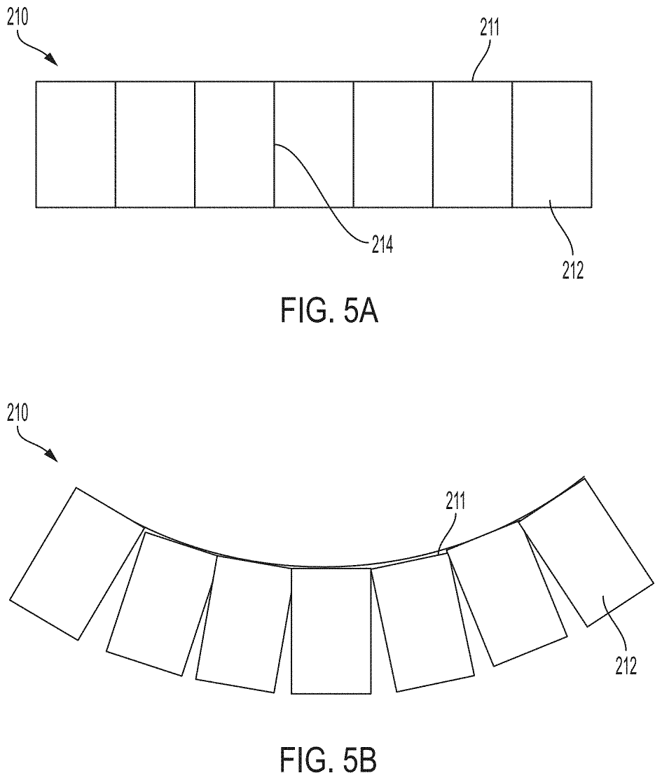

FIGS. 5a and 5b show a body 210 and treats 212. Similarly to body 10, in body 210 the treats 212 are connected to one another at connection edge 211. The separation between treats 212 can be formed with a mold, or via cutting away material. Body 210 can have partition lines 214 that result from the cutting away of material. Connection edge 211 can include (in addition to material that treats 212 are made of) a flexible material to allow for the spreading apart of treats 212 shown in FIG. 5b. In the embodiment of FIGS. 5a and 5b, treats 212 are square or rectangular.

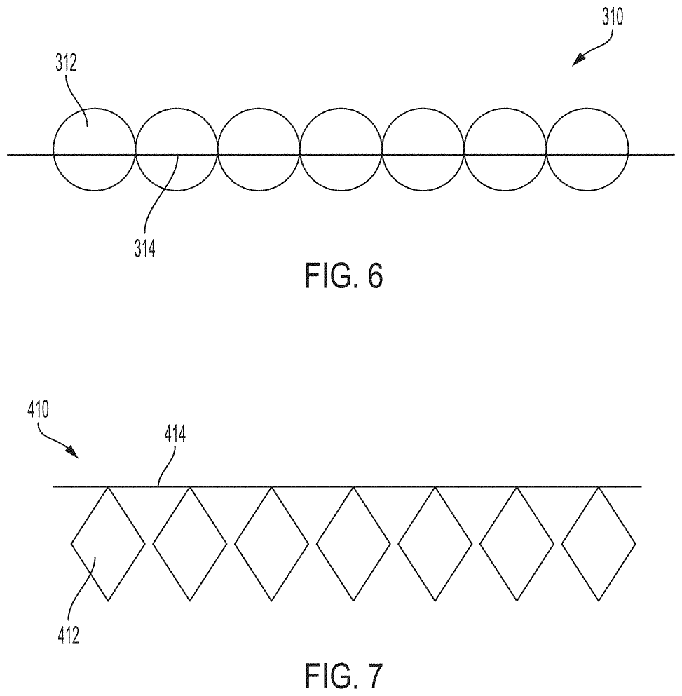

FIG. 6 shows an embodiment of a body 310 where treats 312 are connected to one another via a string 314 that passes through each of the treats individually. Treats 312 are circular in this embodiment.

FIG. 7 shows an embodiment of a body 410 where treats 412 are connected to one another via an adhesive strip 414. In this embodiment, treats 412 are diamond-shaped, and connected to strip 414 at a point of the diamond. In this embodiment, treats 412 are not connected to one another via treat material, but rather through strip 414.

In any of the above-described embodiments, the treats can be connected to one another via treat material. Alternatively, in any of the above-described embodiments, the treats can be connected to one another via adhesive, edible adhesive, tape, adhesive tape, a thread or string, a dowel through the threats, or other suitable connection methods. Using the material of the treats itself as a connection mechanism is beneficial in that it is simpler, and limits the number of materials used. The present disclosure contemplates that a plurality of individual treats can be connected to one another in any of the above-described bodies, such as up to seven or more treats, or thirteen or more treats.

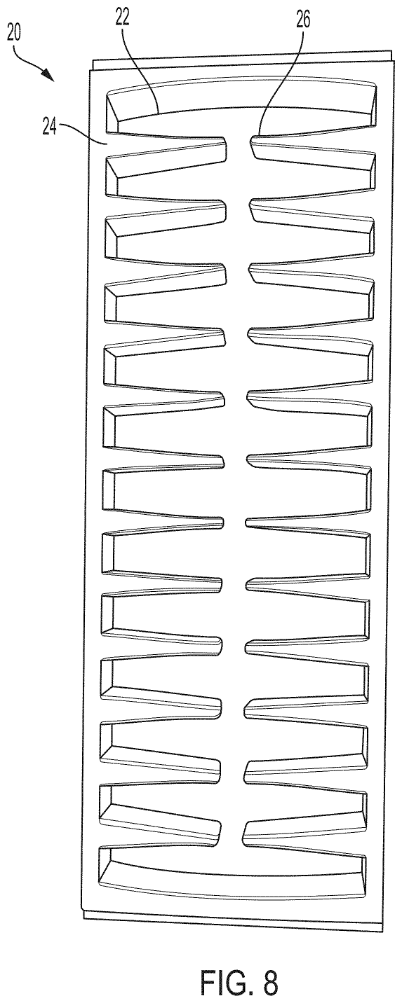

FIG. 8 shows mold 20, into which material to make the treats of the present disclosure can be poured. Mold 20 has a plurality of main cavities 22 to form the body of the treat, for example treat 112. Further, cavities 22 are separated or defined by dividers 24. There is a gap 26 in each divider 24. Thus, when the treats are prepared, the individual treats are connected to one another with a narrow area of material that can easily be broken to separate the treats. Mold 20 can be used as an alternative to the cutting method described above with respect to body 10. Cavities 22 can have any desired shape. Gap 26 can be located anywhere along the cavity 22, so that the treats can be connected to one another anywhere along their circumference.

In the context of the present specification, the term “narrow” is not defined by any particular dimension. A “narrow” section of a treat body will be shorter in width than the overall width of the treat body. In treat bodies 10, 110, 210, 310, and 410, there is a section between individual treats where the edible treat material is cut away. This narrow section should be thick or long enough so that the treat bodies will hold together when no pressure is applied. The narrow section should be thin or short enough so that individual treats can be snapped off or separated from the body without significant difficulty. Individual treats can be separable with manual force, or with the aid of the pushers in the dispensers discussed below.

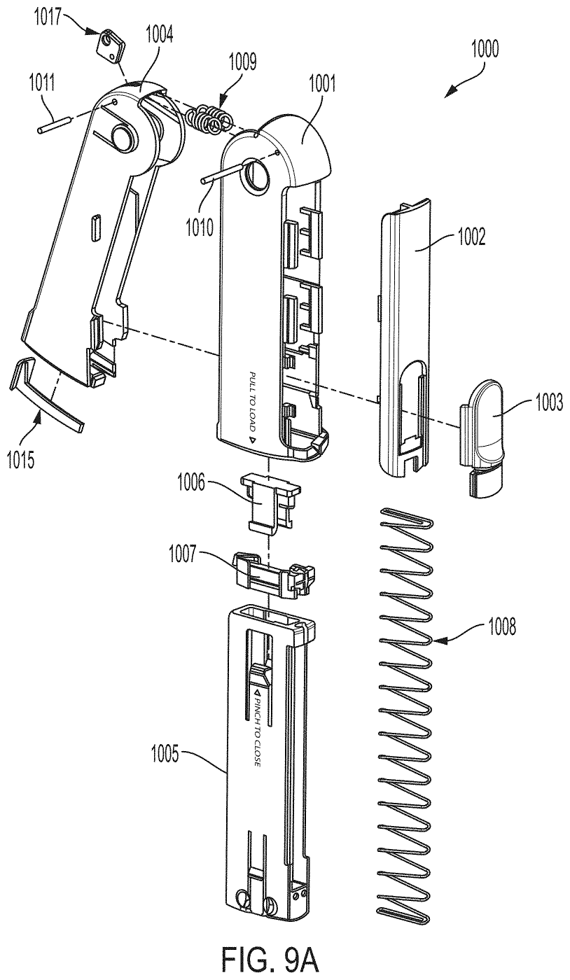

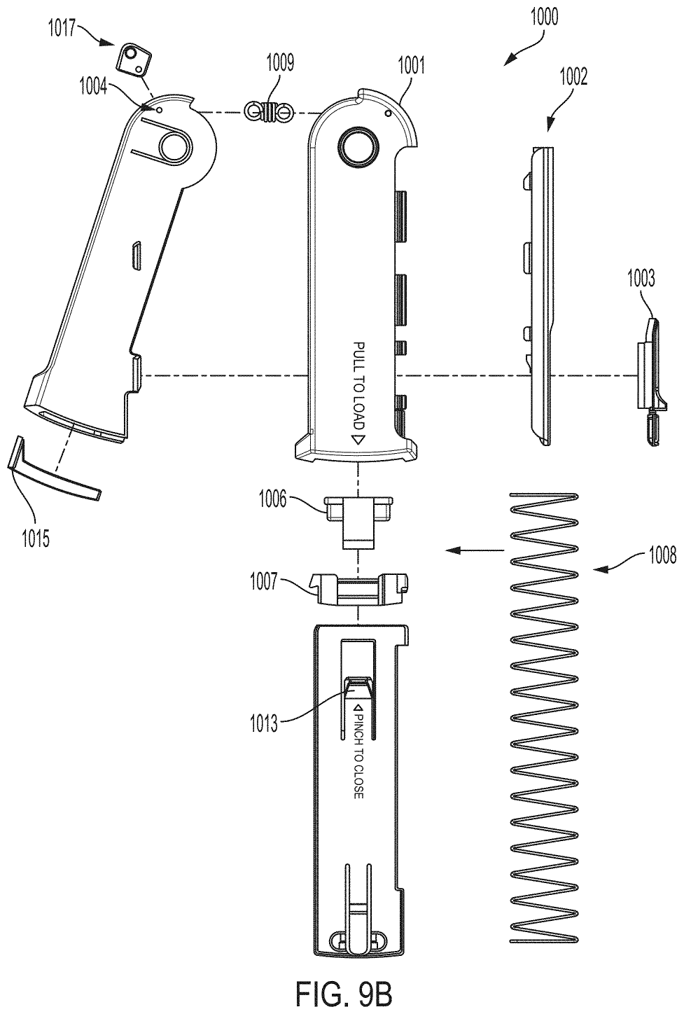

Referring to FIGS. 9a-14c, a dispenser 1000 of the present disclosure is shown. Dispenser 1000 has main housing 1001, front cap 1002 connected to main housing 1001, elastomer flap 1003 connected to front cap 1002, trigger sleeve 1004, and treat sleeve 1005. In the manner described in greater detail below, treat sleeve 1005 can slide out from main housing 1001, so that a user can load a body of treats (for example body 10 of the present disclosure) into treat sleeve 1005. The user then pushes treat sleeve 1005 back into main housing 1001. By squeezing or pushing trigger sleeve 1004 the user can eject a treat from the treat body out through an opening in housing 1001 and cap 1002. Flap 1003 moves aside to uncover an opening in front cap 1002 through which the treat is dispensed, so that the treat can be either removed manually by the user, or fed directly to the animal.

Thus, as previously described, dispenser 1000 provides a very convenient way for a user to deliver treats to an animal. Main housing 1001 is easy for a user to grip, and there are several different ways for the user to hold dispenser 1000. The opening through which the treat is dispensed can be on the bottom or the top of dispenser with respect to the ground. Trigger sleeve 1004 is easy to squeeze, however dispenser 1000 is held. The opening through which the treat is dispensed can be far enough away from the user's hands, so that the risk of getting bitten when dispensing the treat is minimized. Further, as described in greater detail below, dispenser 1000 can collapse into a small profile for easy carrying in a pants pocket, purse, pouch, or other container.

Referring specifically to FIGS. 9a and 9b, dispenser 1000 also has treat sleeve cap 1006, treat sleeve follower 1007, and treat sleeve spring 1008. When assembled, sleeve spring 1008 is between cap 1006 and follower 1007 at one end of sleeve 1005. When a user loads a body of treats into sleeve 1005 in the manner described below, spring 1008 applies pressure to follower 1007 and the treat body, to move the body along so that the next treat can be dispensed. The present disclosure also contemplates that other devices to apply pressure to and move the treat body can be used, other than the specific spring and follower mechanism shown.

Again as seen in FIGS. 9a and 9b, pivot sleeve 1004 is rotatably connected to housing 1001 via a pivot pin 1010. A spring 1009 can apply tension to sleeve 1004 so that the latter is biased toward an open position, i.e. a position tilted away from housing 1001. An additional pin 1011 can be inserted through sleeve 1004 to keep spring 1009 in place. The present disclosure also contemplates other devices for connecting sleeve 1004 to housing 1001 and keeping them in tension, other than the pin and spring mechanism shown.

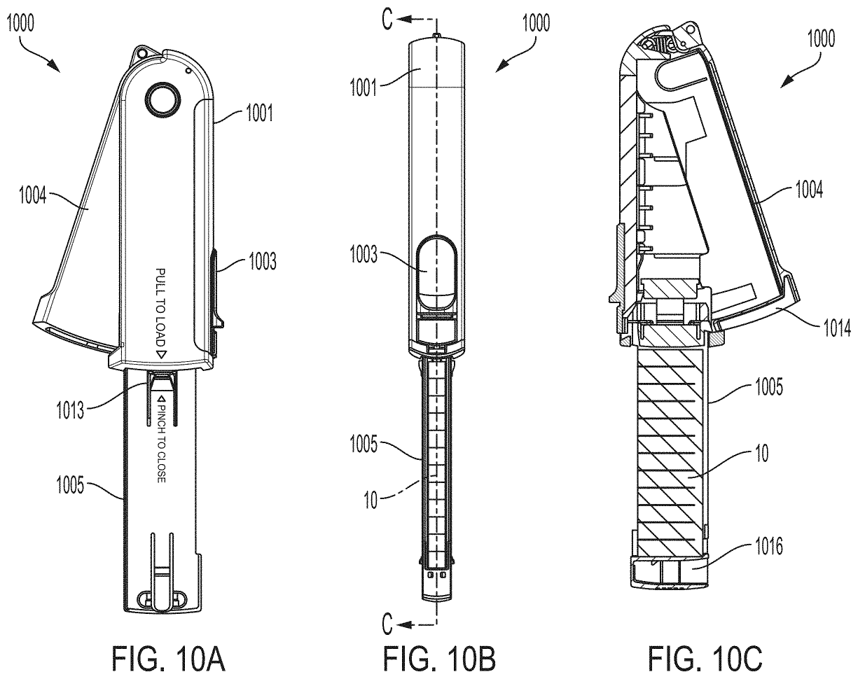

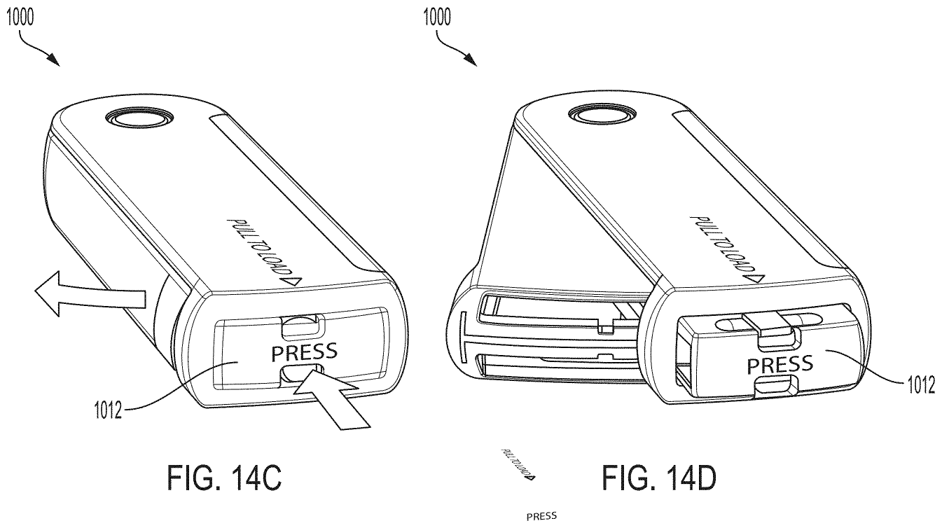

FIGS. 10, 10b, and 10c show dispenser 1000 with sleeve 1005 in an extended position for loading, with body 10 of the present disclosure within sleeve 1005. As seen in FIGS. 14a, 14b, 14c, and 14d, dispenser 1000 has a mechanism whereby a user can press on a bottom surface 1012 of sleeve 1005. This allows sleeve 1005 to project partially out of the bottom of housing 1001 (as shown in FIGS. 14a and 14b). The user can then pull on sleeve 1005, so that it extends substantially fully outside of housing 1001, as shown in FIGS. 10a-10c. When a treat body is loaded in sleeve 1005 (in the shown embodiment body 10), the user can push sleeve 1005 substantially all the way back up into housing 1001. Tabs 1013 on the side of sleeve 1005 can be a locking mechanism to hold sleeve 1005 within housing 1001. The user can squeeze tabs 1013 as they are sliding sleeve 1005 back into housing 1001.

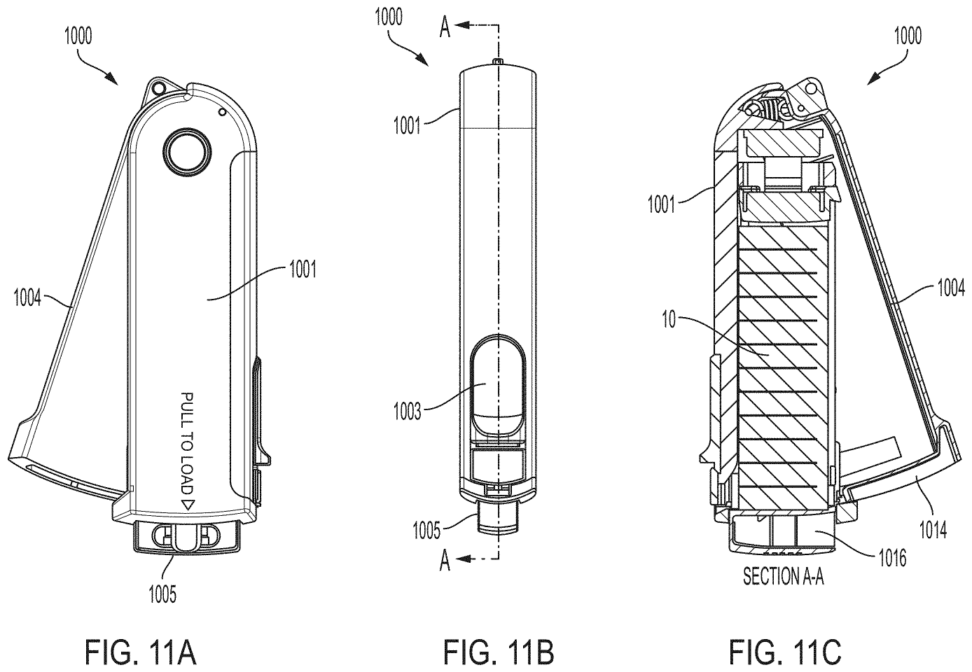

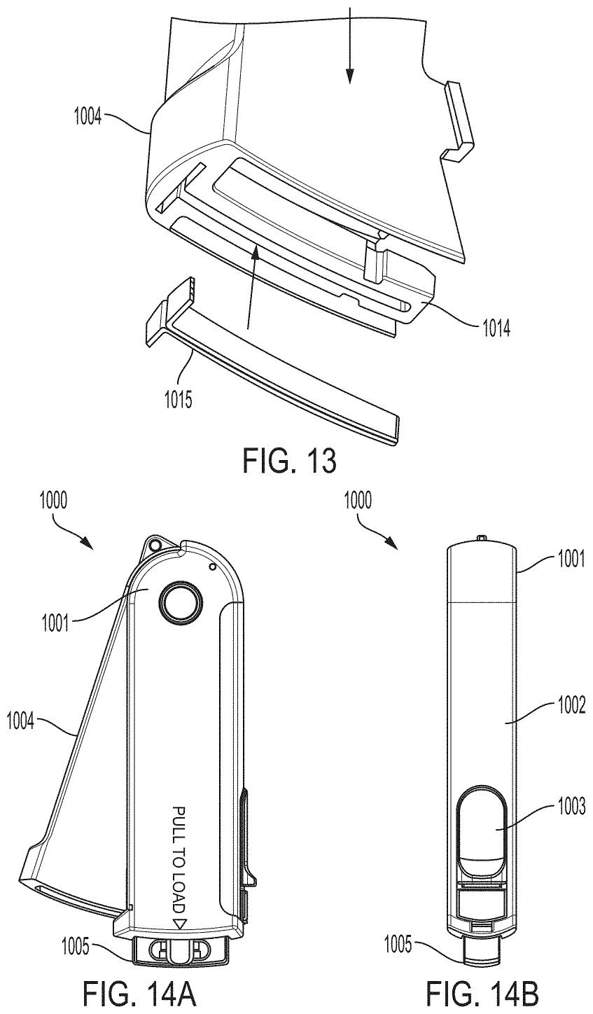

FIGS. 11a, 11b, and 11c show dispenser 1000 with a full sleeve 1005. To dispense a treat, the user squeezes trigger sleeve 1004 toward housing 1001. Trigger sleeve 1004 has a pusher 1014 on a bottom edge thereof, which can be reinforced with a brace 1015. When the user squeezes trigger sleeve 1004, pusher 1014 and brace 1015 contact the bottom-most treat in sleeve 1005, and eject it though the hole in housing 1001 near flap 1003. FIG. 13 shows a detailed image of pusher 1014 and sleeve 1015. As the trigger recedes due to the biasing action of spring 1009, sleeve spring 1008 and follower 1007 push the treat body downward, so that a new treat is in position to be dispensed.

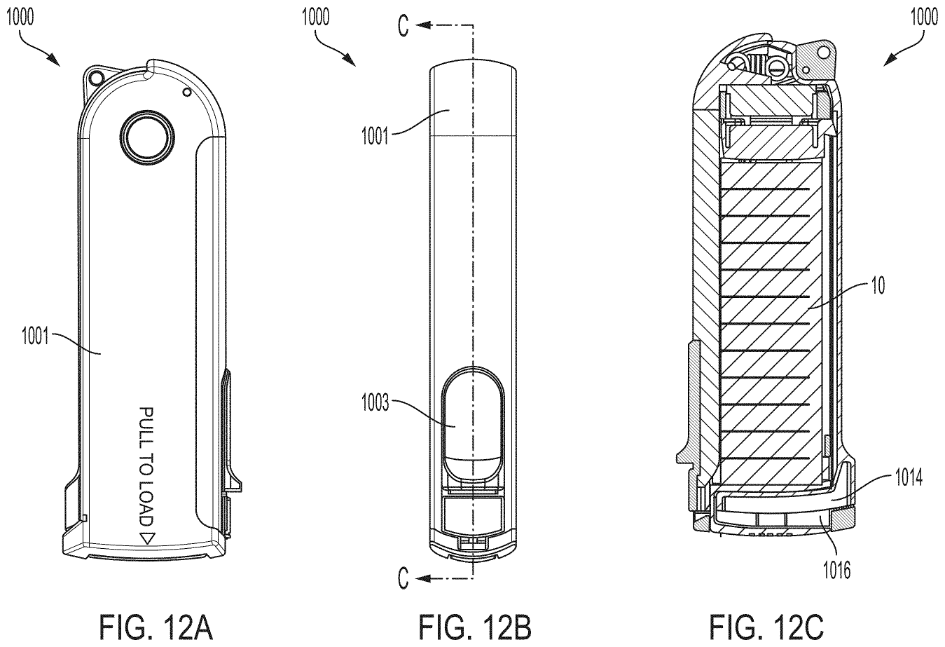

One of the unique features about dispenser 1000 is that pusher 1014, which ejects the treat, is on the opposite end of trigger sleeve 1004 from the pivot at pin 1010. This allows for a compact design, as trigger sleeve 1004 can wrap around treat sleeve 1005, and when trigger sleeve 1004 is in a closed position, dispenser 100 has the slim profile shown in FIG. 12a.

FIGS. 12a, 12b, and 12c show dispenser 1000 with the trigger sleeve 1004 collapsed into treat sleeve 1005 and housing 1001. To do so, the user again pushes on bottom surface 1012 of treat sleeve 1005, so that treat sleeve does not project from the bottom of housing 1001. Treat sleeve has a cavity 1016 at a bottom end thereof, for receiving pusher 1014. The user can squeeze trigger sleeve 1004 so that pusher 1014 and brace 1015 are within cavity 1016, and release bottom surface 1012. In this way, dispenser 1000 has the slim profile shown in FIGS. 12a-12c, with the trigger sleeve 1004 in a collapsed position. To release trigger sleeve 1004 and begin dispensing treats, the user pushes on bottom surface 1012 in the manner described above.

Front cap 1002 can be molded separately, and snapped together with main housing 1001, or they may be molded as one component. Flap 1003 can have flanges thereon, so that when front cap 1002 and housing 1001 are separate components, the flanges of flap 1003 can be pressed between cap 1002 and housing 1001 when assembled. Main housing 1001 may also have a lanyard holder 1017 connected or comolded thereto, so that a user may run a string through lanyard holder 1017.

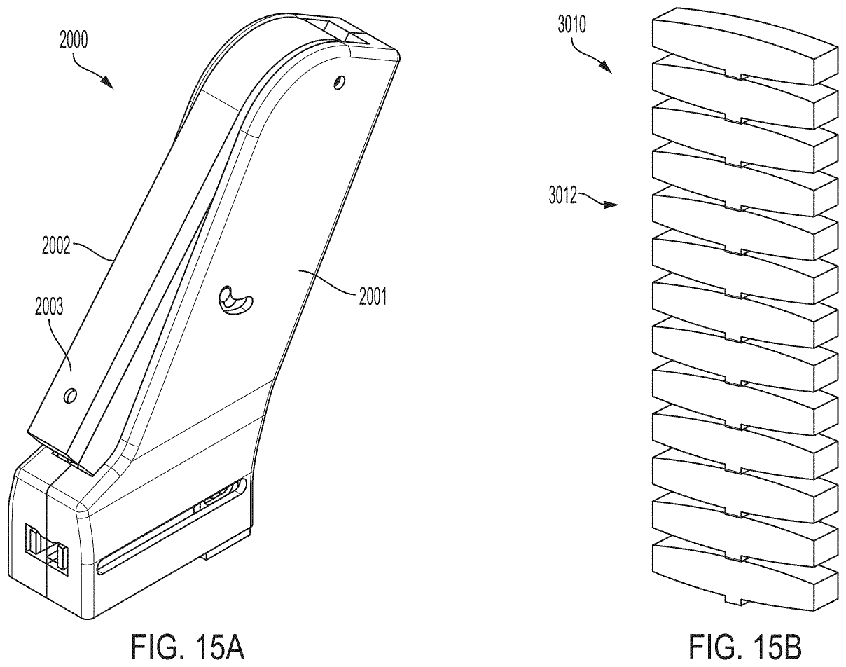

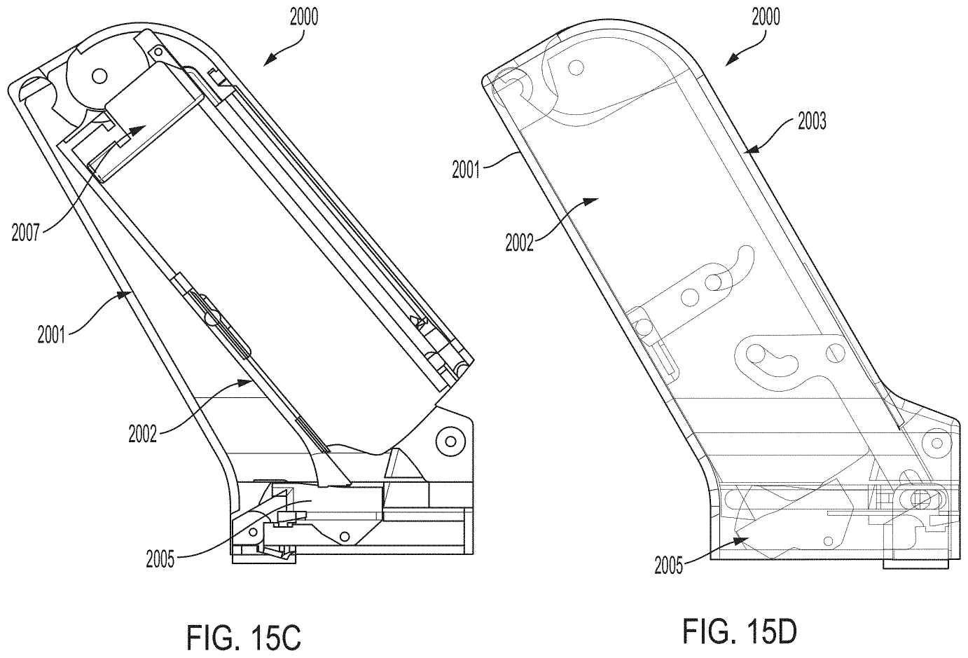

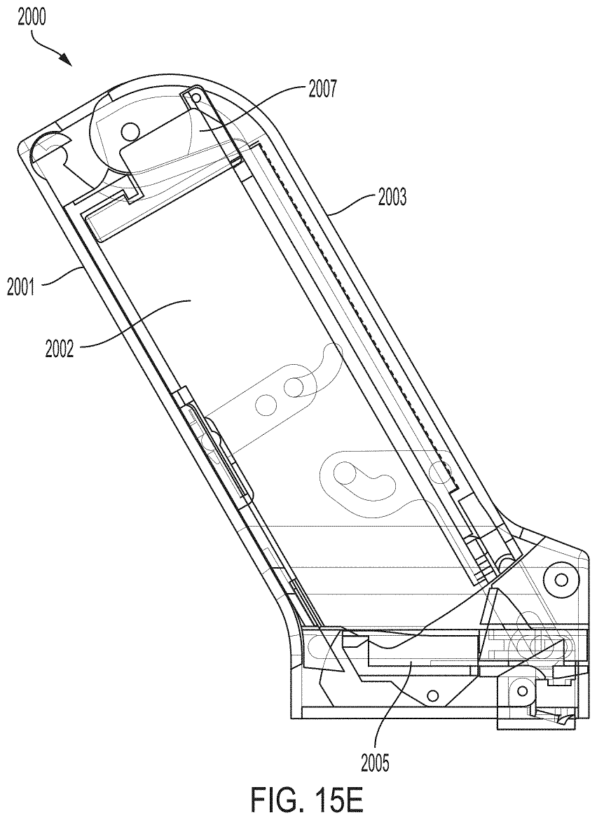

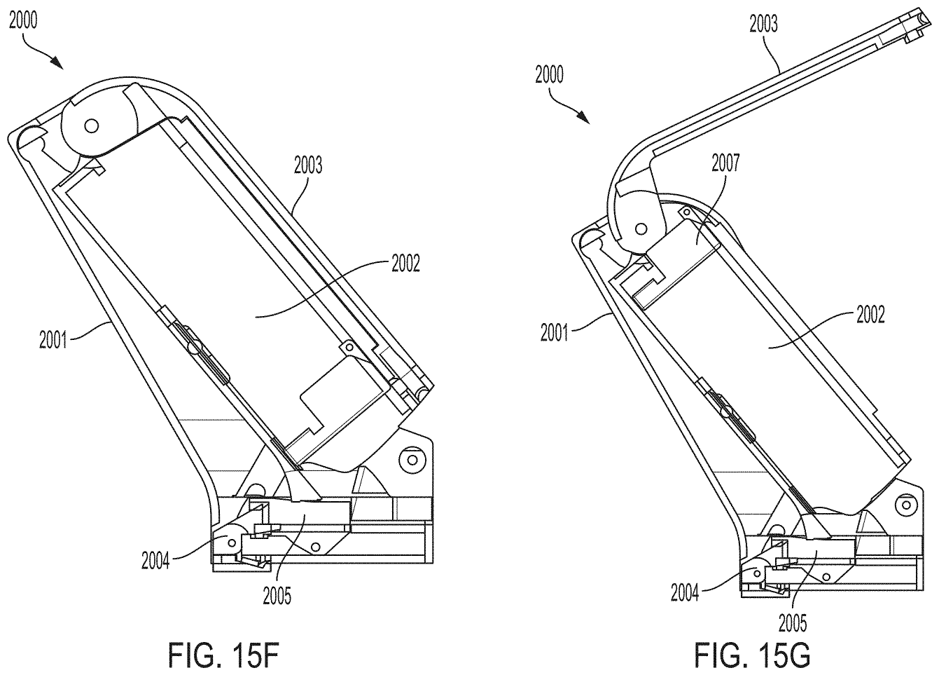

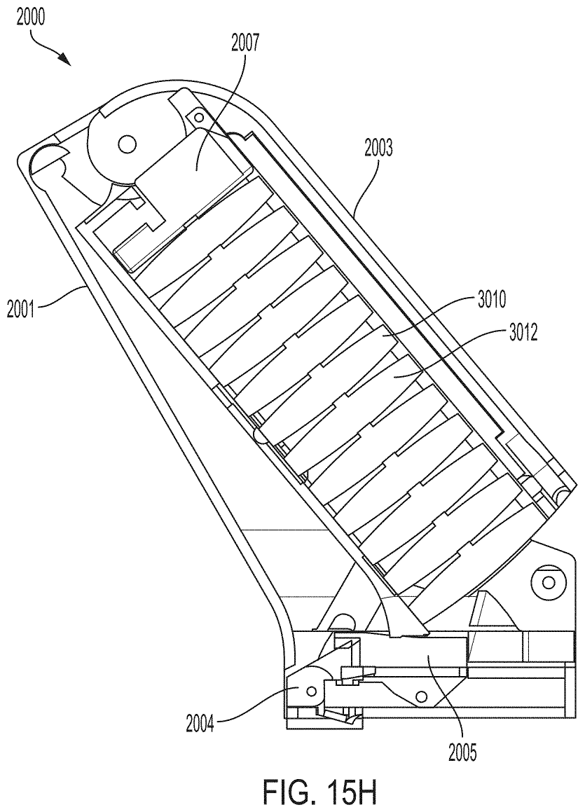

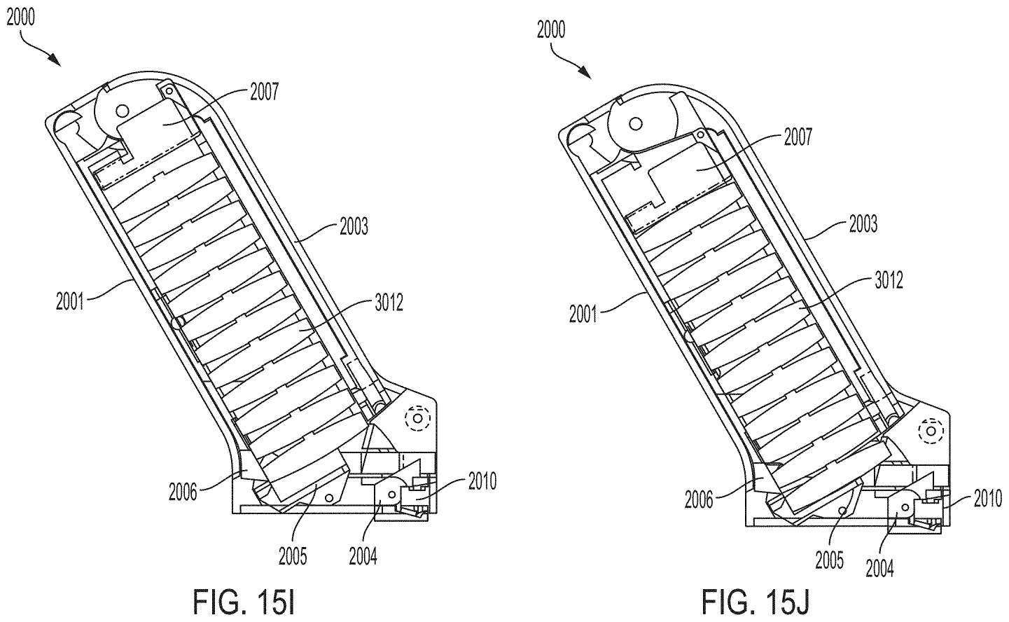

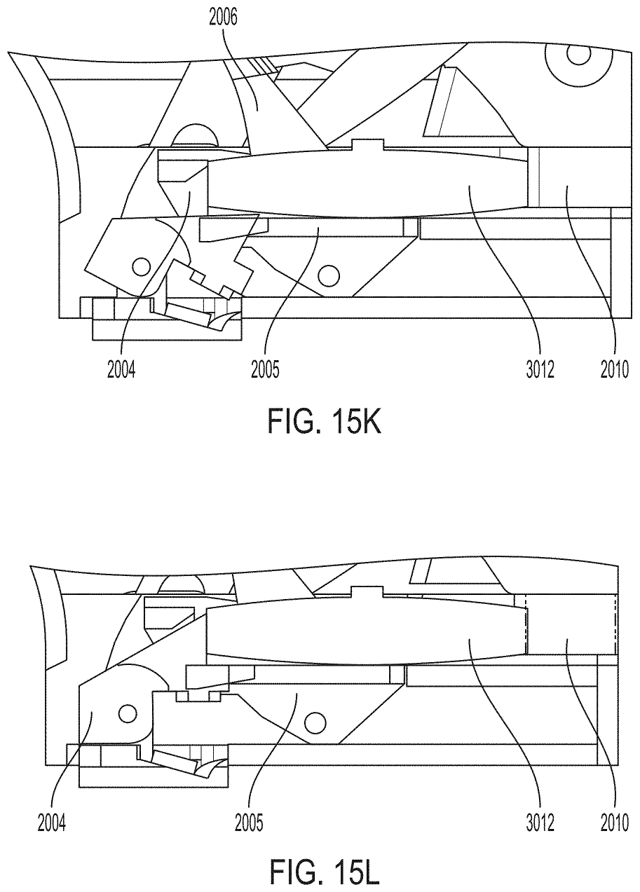

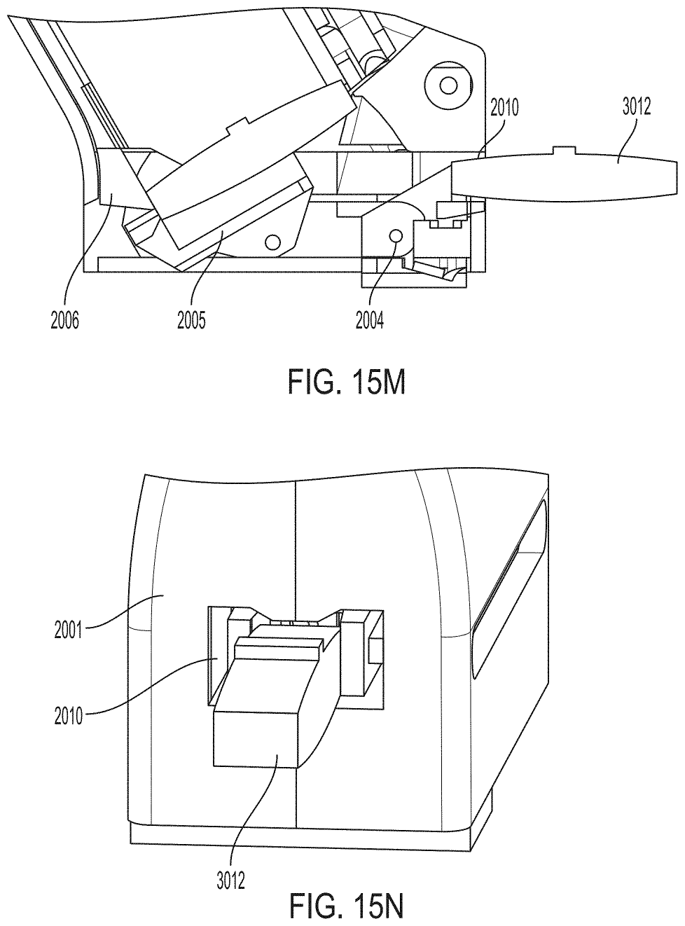

FIGS. 15a-15n show drawings of a dispenser 2000 of the present disclosure that can be used to dispense treats 3012. The dispenser 2000 has a main body or housing 2001 with a storage space therein to hold treats 3012. As described in greater detail below, when a user depresses a trigger, an internal cutter separates one treat, and a pusher moves the treat out so that it can be grabbed by the user or the animal.

Body 3010, with treats 3012 are made with the mold of FIG. 8. Body 3010 is inserted into the front of dispenser 2000. The space in which body 3010 is stored is defined primarily by housing 2001 and trigger sleeve 2002. A front-loading arm 2003 can be connected to housing 2001 and sleeve 2002 so that it rotates out and upward (FIG. 15g), in a similar manner to that of the top of a stapler for loading. Extension spring pusher 2007 is within the shape defined by housing 2001 and sleeve 2002. When body 3010 is placed in the space, pusher 2007 applies force, to advance body 3010 as individual treats 12 are dispensed in the manner described below. When loader 2003 is in a raised position, it draws pusher 2007 to one side of the space in housing 2001, to allow for the loading of body 3010 (FIG. 15g). Closing loader 2003 causes pusher 2007 to apply the force to body 3010 (FIG. 15h).

Trigger sleeve 2002 extends almost the full height of dispenser 2000 and pivots about an axis at the top. Body 3010 with treats 3012 rock back and forth with trigger sleeve 2002. When trigger sleeve 2002 is depressed (FIG. 15i), body 3010 drops and a bottom one of treats 3012 enters the bottom-most section. Releasing trigger sleeve 2002 separates the bottom treat 3012 from body 3010, and places it in a rocking base 2005. A sliding back 2006 connected to trigger sleeve 2002 can move rocking base 2005 so that the latter can receive treat 3012. The forces caused by the motion of these components act on body 3010 strongly enough to detach the bottom-most treat 3012 from body 3010.

When trigger sleeve 2002 is released, a main pusher 2004 slides under and behind the bottom-most treat 3012 (FIGS. 15k, 15l). Upon the next push of trigger sleeve 2002, the bottom-most treat 3012 is pushed out of an opening 2010. The trigger sleeve 2002 can be designed such that treat 3012 sticks out about ¾ of the length of the treat, or any other suitable amount, such as ½ or ¼ length. A flexing tab 2011 on the housing 2001 can hold treat 3012 in place while it is partially ejected. When trigger sleeve 2002 is released a second time, the above-described process for ejecting a treat 3012 begins again.

As long as trigger sleeve 2002 is held down, the back of the dispensed treat 3012 is gripped at the front opening of the dispenser. As soon as trigger sleeve 2002 is released, treat 3012 can drop. The purpose for this sequence described in the last two lines is so that treat 3012 can be held in a position for the animal to take it. Otherwise, the treat can just be dropped to the ground. The user could also squeeze trigger sleeve 2002 very quickly, in which case treat 3012 would exit at a higher speed and launch forward without being held at opening 2011.

There are other methods of dispensing a treat 3012 that are contemplated herein. For example, trigger sleeve 2002 may be in the in the back instead of the front of dispenser 2000. Dispenser 2000 may employ a much simpler mechanism with a slightly different sequence of operations. Dispenser 2000 may also include a cutting blade to more reliably separate treats 3012 before dispensing. These alternative designs will still move, carry, and dispense a row of connected treats which advance one at a time. The alternative designs would also have the feature wherein the dispensed treat 3012 is held until trigger sleeve 2002 is released. Further, dispenser 2000 can be designed to hold any of the embodiments shown in FIGS. 1-7 of the present application, or any other embodiments of body 10.

Either of the treat dispensers 1000, 2000 described herein can be used with any of the treat bodies 10, 110, 210, 310, and 410 described herein. Treat dispensers 1000 and 2000 may also dispense one or a plurality of treats that are loosely placed in the treat sleeves and/or are unconnected.

Unless otherwise indicated, the terms “front”, “back”, “top”, and “bottom” are used for ease of description, and are not meant to impart any particular orientation or direction to the described components.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A dispenser for dispensing a plurality of pet treats, comprising:
a housing comprising a hollow interior;
a treat sleeve comprising a hollow interior for storing the pet treats, wherein the treat sleeve selectively moves from an extended position substantially protruding from the housing, and a retracted position substantially within the hollow interior of the housing; and
a trigger sleeve having a hollow interior, wherein the trigger sleeve is pivotably connected to the housing at a first end of the trigger sleeve, and comprises a pusher at a second end of the trigger sleeve,
wherein, when the trigger sleeve is in a first position, the trigger sleeve is substantially outside the housing, and when the trigger sleeve is in a second position, the trigger sleeve is substantially within the hollow interior of the housing.

2. The dispenser of claim 1, wherein, when the trigger sleeve is in the second position and the treat sleeve is in the retracted position, the trigger sleeve surrounds the treat sleeve within the hollow interior of the housing.

3. The dispenser of claim 1, wherein, when the trigger sleeve is in the second position and the treat sleeve is in the retracted position, the pusher of the trigger sleeve is within the hollow interior of the treat sleeve.

4. The dispenser of claim 1, wherein the housing and the trigger sleeve are connected to one another so that the trigger sleeve is biased toward the first position.

5. The dispenser of claim 4, wherein the trigger sleeve is biased toward the first position with a spring.

6. The dispenser of claim 1, wherein the treat sleeve further comprises an end cap at a first end, a treat pusher in the hollow interior, and a spring in the hollow interior, wherein the spring is between the end cap and the treat pusher, so that the treat pusher is biased toward a second end of the treat sleeve.

7. The dispenser of claim 1, wherein the pusher of the trigger sleeve is reinforced with a steel brace connected thereto.

8. The dispenser of claim 1, further comprising a housing cap and a flap, wherein the housing cap has a hole therein, and the flap is connected to the housing cap over the hole, so that the pusher ejects treats within the treat sleeve out through the hole.

9. The dispenser of claim 2, further comprising a cavity at an end of the treat sleeve, so that when the trigger is in the second position and the treat sleeve is in the retracted position, the pusher of the trigger sleeve is within the cavity.

10. The dispenser of claim 1, wherein further comprising a latching mechanism, whereby the treat sleeve can be selectively moved from the retracted position to a partially extended position by pressing on an end of the treat sleeve.

11. The dispenser of claim 1, further comprising a treat body in the treat sleeve, wherein the treat body comprises a plurality of treats made of a mass of edible material, wherein the mass comprises cutaway positions, so that the plurality of treats are interconnected to one another by narrow connection points made of the material, so that the treats can be separated individually.

12. A treat body comprising a plurality of interconnected treats, wherein the treat body comprises:
a mass of edible material, wherein the mass comprises cutaway positions, so that the plurality of treats are interconnected to one another by narrow connection points made of the material, so that the treats can be separated individually.

13. The treat body of claim 12, wherein the treats have a shape selected from the group consisting of a cylinder, rectangular, an ellipse, a circle, a triangle, or a diamond.

14. The treat body of claim 12, wherein the treats have a shape that is either a cylinder or a rectangular solid.

15. The treat body of claim 12, wherein the treats are further connected to one another with an adhesive.

16. A dispenser, comprising:
a housing;
a trigger sleeve, wherein the trigger sleeve is pivotably connected to the housing, and an interior space is defined by the housing and the trigger sleeve;
a treat body in the interior space, wherein the treat body comprises a plurality of treats made of a mass of edible material, wherein the mass comprises cutaway positions, so that the plurality of treats are interconnected to one another by narrow connection points made of the material, so that the treats can be separated individually; and
an opening in the housing, so that when the trigger sleeve moves from a first position to a second position, one of the plurality of treats is detached from the treat body and passed through the opening.

17. The dispenser of claim 16, further comprising a base and a pusher within the housing, so that when the one of the plurality of treats is detached, it is on the base, and pushed through the opening by the pusher.

18. The dispenser of claim 16, further comprising a sleeve pusher within the trigger sleeve, wherein the sleeve pusher is biased, so that it applies pressure to one end of the treat body.

19. The dispenser of claim 16, further comprising a front-loading arm connected to the trigger sleeve, wherein the front-loading arm is rotatable connected to the trigger sleeve, and selectively allows and closes off access to the interior space, for loading of the treat body.

20. The dispenser of claim 19, further comprising a sleeve pusher within the trigger sleeve, wherein the sleeve pusher is biased, so that it applies pressure to one end of the treat body, and wherein the front-loading arm is connected to the sleeve pusher.
